(19) United States
(12) Patent Application Publication
(10) Pub. No.: US 2023/0056684 A1
(43) Pub. Date: Feb. 23, 2023

(54) SIGNAL TRANSFER SYSTEM, TERMINAL FUNCTION APPARATUS, SUBSTITUTE TRANSFER AGENT APPARATUS AND SIGNAL TRANSFER METHOD

(71) Applicant: NIPPON TELEGRAPH AND TELEPHONE CORPORATION, Tokyo (JP)

(72) Inventors: Keita NISHIMOTO, Musashino-shi, Tokyo (JP); Kota ASAKA, Musashino-shi, Tokyo (JP); Takashi YAMADA, Musashino-shi, Tokyo (JP); Junichi KANI, Musashino-shi, Tokyo (JP)

(73) Assignee: NIPPON TELEGRAPH AND TELEPHONE CORPORATION, Tokyo (JP)

(21) Appl. No.: 17/796,866

(22) PCT Filed: Feb. 7, 2020
(86) PCT No.: PCT/JP2020/004917

§ 371 Date: Aug. 1, 2022

(51) Int. Cl. H04L 45/76

(52) U.S. Cl. CPC H04L 45/76

(57) ABSTRACT

A terminal function device and a proxy transfer agent device generate, on mutually-connecting physical lines, logical paths to be correlated with physical port transmitting/receiving units. In a case of receiving a signal received at one of the physical port transmitting/receiving units, the terminal function device sends the signal out to a logical path corresponding to the physical port transmitting/receiving unit that received this signal. In a case of receiving a signal through the logical path, the proxy transfer agent device correlates the signal with information identifying the physical port transmitting/receiving unit corresponding to the logical path that received this signal, and transfers the information along with the signal. Ina case of sending out a signal to the logical path, the proxy transfer agent device sends out the signal to the logical path corresponding to the physical port transmitting/receiving unit specified as a transfer destination of the signal. In a case of receiving a signal through the logical path, the terminal function device sends out the signal from the physical port transmitting/receiving unit corresponding to the logical path that received the signal.

### TECHNICAL FIELD

The present invention relates to a signal transfer system, a terminal function device, a proxy transfer agent device, and a signal transfer method.

### BACKGROUND ART

In order to increase flexibility of network functions for communication, and to reduce hardware size and cost, and so forth, there is being studied a split architecture, in which network functions conventionally realized within a single housing are separated into functions situated in a terminal (hereinafter referred to as terminal functions) and functions for performing complicated processing and control (hereinafter referred to as central functions), with central functions being consolidated at a central portion of the network.

For example, in the field of optical fixed access networks, there has been proposed a split architecture, in which OLT (Optical Line Terminal) functions are separated into terminal functions realized as small-size hardware of a module type insertable in a switch, and central functions that are realized by software, with the central functions being consolidated in a DC (Data Center), for example, thereby realizing OLT functions (e.g., see NPL 1).

Also, in the field of wireless access networks as well, study is being advanced regarding a split architecture called C-RAN (Centralized-Radio Access Network) in which functions conventionally implemented as a single base station device are separated into a parent station and a child station (e.g., see NPL 2).

Generally, functions such as transmission and reception of signals, conversion of signals, and transfer of packets, and so forth, are implemented as terminal functions in such a split architecture. However, the terminal functions are preferably configured in a simple and concise manner, from an economical perspective.

### CITATION LIST

### Non Patent Literature

[NPL 1] Keita Nishimoto et al., “Predictive Dynamic Bandwidth Allocation Based on the Correlation of the Bi-directional Traffic for Cloud-based Virtual PON-OLT”, Proc. IEEE, 2017 IEEE International Workshop Techical Committee on Communications Quality and Reliability (CQR), 2017, pp. 1-6

[NPL 2] Kenji Miyamoto, “Radio over Fiber gizyutu no musen akusesu nettowaku heno togo ni kansuru kenkyu (Research on integration of Radio over Fiber technology to wireless access networks) (doctoral thesis)”, Osaka University repository, January 2017

### SUMMARY OF THE INVENTION

### Technical Problem

Now, in recent years, introduction of SDN (Software Defined Network) protocols, such as OpenFlow, P4 (Programming Protocol-Independent Packet Processors), and so forth, is being advanced to realized central control of networks. Performing control of devices provided with terminal functions (hereinafter, referred to as terminal function devices) using such new protocols requires the terminal function devices to perform transfer processing of an even higher level than conventionally, such as packet-in, packet-out, IP (Internet Protocol) address rewriting, and so forth, for example.

However, there is a problem that realizing such high-level transfer processing with terminal function devices is difficult from an economical perspective.

In view of the foregoing, it is an object of the present invention to provide technology in which new communication protocols such as SDN and so forth can be flexibly added in a case of employing a split architecture separated into central functions and terminal functions.

### Means for Solving the Problem

An aspect of the present invention is a signal transfer system, including: a terminal function device, including a plurality of physical port transmitting/receiving units that perform transmission/reception of signals through physical lines respectively connected thereto, a transfer processing unit that connects to each of the physical port transmitting/receiving units and that performs transfer processing of signals output by the physical port transmitting/receiving unit, or signals output to the physical port transmitting/receiving units, and a terminal-side logical path transmitting/receiving unit that generates a logical path to be correlated with the physical port transmitting/receiving unit on one of the physical lines, and that, in a case of receiving a signal from the transfer processing unit, sends out the signal to a logical path corresponding to the physical port transmitting/receiving unit that received this signal, and in a case of receiving a signal through the logical path, outputs the signal to the transfer processing unit with the physical port transmitting/receiving unit corresponding the logical path that received this signal specified as a transfer destination thereof; and a proxy transfer agent device, including a proxy-side logical path transmitting/receiving unit that, together with the terminal function device, generates the logical paths correlated with the physical port transmitting/receiving units, and that, in a case of receiving a signal through the logical paths, correlates information identifying the physical port transmitting/receiving unit corresponding to the logical path that received this signal with the signal, and outputs the information along with this signal, and in a case of sending out a signal to the logical path, sends out the signal to a logical path corresponding to the physical port transmitting/receiving unit specified as a transfer destination of this signal.

An aspect of the present invention is a terminal function device, including: a plurality of physical port transmitting/receiving units to each of which a physical line is connected, and that perform transmission/reception of signals through the physical lines; a transfer processing unit that connects to each of the physical port transmitting/receiving units and that performs transfer processing of signals output by the physical port transmitting/receiving unit, or signals output to the physical port transmitting/receiving units; and a terminal-side logical path transmitting/receiving unit that generates a logical path to be correlated with the physical port transmitting/receiving unit on one of the physical lines, and that, in a case of receiving a signal from the transfer processing unit, sends out the signal to a logical path corresponding to the physical port transmitting/receiving unit that received this signal, and in a case of receiving a signal through the logical path, outputs the signal to the transfer processing unit with the physical port transmitting/receiving unit corresponding the logical path that received this signal specified as a transfer destination thereof.

An aspect of the present invention is a proxy transfer agent device that connects to a terminal function device having a plurality of physical port transmitting/receiving units that perform transmission/reception of signals through physical lines respectively connected thereto, via one of the physical lines. The proxy transfer agent device includes: a proxy-side logical path transmitting/receiving unit that generates the logical paths correlated with the physical port transmitting/receiving units on the physical lines connected to the terminal function device, and that, in a case of receiving a signal through the logical paths, correlates information identifying the physical port transmitting/receiving unit corresponding to the logical path that received this signal with the signal, and outputs the information along with this signal, and in a case of sending out a signal to the logical path, sends out the signal to a logical path corresponding to the physical port transmitting/receiving unit specified as a transfer destination of this signal.

An aspect of the present invention is a signal transfer method in a signal transfer system including a terminal function device that includes a plurality of physical port transmitting/receiving units that perform transmission/reception of signals through physical lines respectively connected thereto, and a proxy transfer agent device that connects to the terminal function device through one of the physical lines. The method includes: the terminal function device and the proxy transfer agent device generating, on the mutually-connecting physical lines, logical paths to be correlated with the physical port transmitting/receiving units; the terminal function device, in a case of receiving a signal received at one of the physical port transmitting/receiving units, sending the signal out to a logical path corresponding to the physical port transmitting/receiving unit that received this signal; the proxy transfer agent device, in a case of receiving a signal through the logical path, correlating the signal with information identifying the physical port transmitting/receiving unit corresponding to the logical path that received this signal, and transferring the information along with the signal; the proxy transfer agent device, in a case of sending out a signal to the logical path, sending out the signal to the logical path corresponding to the physical port transmitting/receiving unit specified as a transfer destination of the signal; and the terminal function device, in a case of receiving a signal through the logical path, sending out the signal from the physical port transmitting/receiving unit corresponding to the logical path that received the signal.

### Effects of the Invention

According to the present invention, new communication protocols such as SDN and so forth can be flexibly added in a case of employing a split architecture separated into central functions and terminal functions.

### BRIEF DESCRIPTION OF DRAWINGS

FIG. 1 is a block diagram illustrating a configuration of a packet transfer system according to a basic embodiment.

FIG. 2 is a diagram illustrating a configuration in which a logical path is generated in the packet transfer system according to the basic embodiment.

FIG. 3 is a diagram showing a configuration of a terminal-side physical-logical correlation table according to the basic embodiment.

FIG. 4 is a diagram showing a configuration of a proxy-side physical-logical correlation table according to the basic embodiment.

FIG. 5 is a block diagram illustrating a configuration of a communication system according to a first embodiment.

FIG. 6 is a flowchart showing a flow of packet-in processing in the first embodiment.

FIG. 7 is a flowchart showing a flow of packet-out processing in the first embodiment.

FIG. 8 is a block diagram illustrating a configuration of a communication system according to a second embodiment.

FIG. 9 is a flowchart showing a flow of detection processing of a connection relation of adjacent switches according to the second embodiment.

### DESCRIPTION OF EMBODIMENTS

(Basic Embodiment)

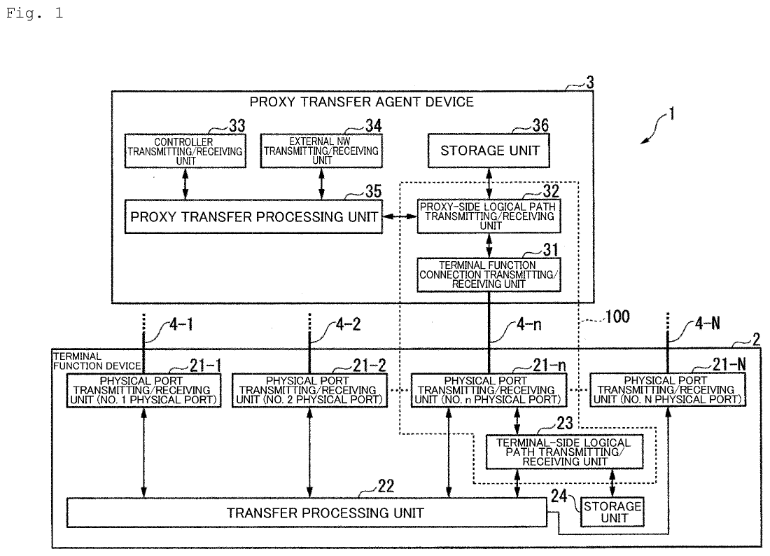

Embodiments of the present invention will be described below with reference to the Figures. FIG. 1 is a block diagram illustrating a configuration of a packet transfer system 1 according to a basic embodiment. The packet transfer system 1 is provided with a terminal function device 2 and a proxy transfer agent device 3.

The terminal function device 2 is provided with an N count of physical port transmitting/receiving units 21-1, 21-2, . . . , 21-n, . . . , 21-N, a transfer processing unit 22, a terminal-side logical path transmitting/receiving unit 23, and a storage unit 24. Here, N is an integer of 2 or more, and the physical port transmitting/receiving unit 21-n represents anyone of the physical port transmitting/receiving units 21-1 to 21-N.

Physical lines 4-1 to 4-N, such as optical fibers or the like for communication, are connected to the respective physical port transmitting/receiving units 21-1 to 21-N. The physical port transmitting/receiving units 21-1 to 21-N each receive packets through the physical lines 4-1 to 4-N to which is each connected, and output the received packets to the transfer processing unit 22.

Now, assumption will be made here that packets include types of packets called data packets, which include data exchanged among users in communication, and types of packets called control packets, which include control signals used for control in communication, for example.

Also, each of the physical port transmitting/receiving units 21-1 to 21-N take in packets that the transfer processing unit 22 outputs, and sends out the packets that are taken in, to the respective physical lines 4-1 to 4-N connected thereto. Physical port identification information by which each of the physical port transmitting/receiving units 21-1 to 21-N can be identified are imparted to each of the physical port transmitting/receiving units 21-1 to 21-N in advance. An example of impartation of physical port identification information, indicated by the names of “No. 1 physical port”, “No. 2 physical port”, . . . , “No. n physical port”, . . . , “No. N physical port”, as an example of physical port identification information, is illustrated in FIG. 1.

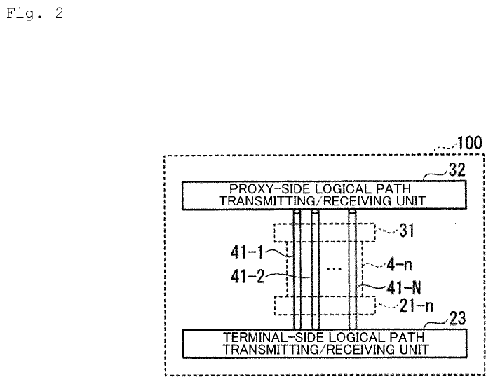

The terminal-side logical path transmitting/receiving unit 23 connects to the physical port transmitting/receiving unit 21-n that connects to the proxy transfer agent device 3 via the physical line 4-n. The terminal-side logical path transmitting/receiving unit 23 generates an N count of logical paths 41-1 to 41-N to be correlated to the physical port transmitting/receiving units 21-1 to 21-N, in a one-on-one manner, between itself and the proxy transfer agent device 3, through the physical port transmitting/receiving unit 21-n and the physical line 4-n. Note that FIG. 2 is a diagram illustrating a configuration example of logical paths 41-1 to 41-N being generated in a configuration within a dashed-line frame denoted by sign 100 in FIG. 1.

Techniques such as a technique for generating by attaching VLAN (Virtual Local Area Network) tags or the like to packets, generating using physical properties such as taking one wavelength as a logical path or the like, for example, are applied as techniques for generating the logical paths 41-1 to 41-N.

Also, upon taking in a packet that the transfer processing unit 22 outputs, the terminal-side logical path transmitting/receiving unit 23 sends this packet to the logical path 41-1 to 41-N that corresponds to the physical port transmitting/receiving unit 21-1 to 21-N that received this packet. Also, upon receiving a packet from the proxy transfer agent device 3 through the logical path 41-1 to 41-N, terminal-side logical path transmitting/receiving unit 23 correlates specification information, specifying as the transfer destination thereof the physical port transmitting/receiving unit 21-1 to 21-N corresponding to the logical path 41-1 to 41-N over which the packet was received, with the packet, and outputs the specification information to the transfer processing unit 22 along with the packet. Physical port identification information, for example, is applied as this specification information.

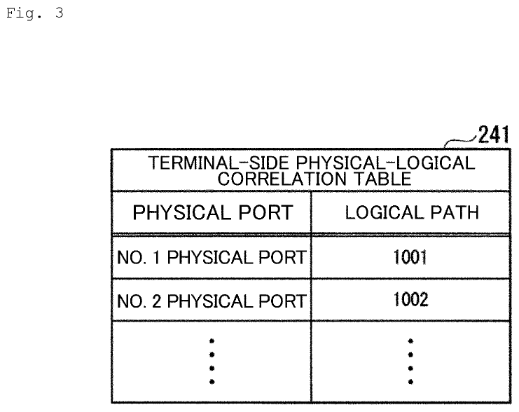

The storage unit 24 stores a terminal-side physical-logical correlation table 241 that has the data format illustrated in FIG. 3. The terminal-side physical-logical correlation table 241 has items of “physical port” and “logical path”, and physical port identification information imparted to the physical port transmitting/receiving units 21-1 to 21-N is written to the “physical port” item in advance. When the terminal-side logical path transmitting/receiving unit 23 generates the logical paths 41-1 to 41-N, the logical path identification information generated and imparted to each of the logical paths 41-1 to 41-N is written to the item of “logical path” by the terminal-side logical path transmitting/receiving unit 23.

In FIG. 3, an example of logical path identification information of “1001”, “1002”, . . . being written is illustrated as an example. As described above, the terminal-side logical path transmitting/receiving unit 23 generates an N count of logical paths 41-1 to 41-N to be correlated to the physical port transmitting/receiving units 21-1 to 21-N in a one-on-one manner. Accordingly, different logical path identification information is written to the “logical path” item, with regard to each physical port identification information written to the “physical port” item in the terminal-side physical-logical correlation table 241.

The transfer processing unit 22 stores transfer conditions set in advance in an internal storage region, takes in packets output by the physical port transmitting/receiving units 21-1 to 21-N, and determines whether or not the packets taken in are packets that match the transfer conditions. Now, the transfer conditions stored in the internal storage region of the transfer processing unit 22 are conditions such as whether a VLAN-ID (IDentifier) included in the packet matches the VLAN-ID set in advance, and conditions such as whether a transmission source IP address included in the packet matches the IP address set in advance, for example. Note that the transfer conditions may include a plurality of conditions.

In a case in which a packet output from a physical port transmitting/receiving unit 21-1 to 21-N matches one of the transfer conditions, transfer processing defined in the matching transfer conditions is applied to the packet that has been taken in, and outputs to one of the transfer destination physical port transmitting/receiving unit 21-1 to 21-N by the transfer processing unit 22. Note that the transfer processing that the transfer processing unit 22 performs is transfer processing that can be realized with a simple configuration as compared to the transfer processing performed by the proxy transfer agent device 3. This is processing as simple as being expressed by an IF-THEN syntax where, in a case in which the transmission source IP address matches the IP address indicated in the transfer conditions, the physical port for sending out is changed, for example.

Also, in a case in which a packet output from a physical port transmitting/receiving unit 21-1 to 21-N matches none of the transfer conditions, the transfer processing unit 22 correlates this packet with information identifying the receiving physical port transmitting/receiving unit 21-1 to 21-N, such as physical port identification information for example, and outputs the information to the terminal-side logical path transmitting/receiving unit 23 along with the packet.

Also, in a case of taking in a packet output by the terminal-side logical path transmitting/receiving unit 23, and specification information specifying a transfer destination correlated with this packet, the transfer processing unit 22 outputs the packet that has been taken in to the physical port transmitting/receiving unit 21-1 to 21-N corresponding to the specification information.

The proxy transfer agent device 3 is provided with a terminal function connection transmitting/receiving unit 31, a proxy-side logical path transmitting/receiving unit 32, a controller transmitting/receiving unit 33, an external NW (Network) transmitting/receiving unit 34, a proxy transfer processing unit 35, and a storage unit 36. The terminal function connection transmitting/receiving unit 31 connects to the physical port transmitting/receiving unit 21-n of the terminal function device 2 via the physical line 4-n.

The proxy-side logical path transmitting/receiving unit 32 generates an N count of logical paths 41-1 to 41-N between itself and the terminal-side logical path transmitting/receiving unit 23, via the physical line 4-n between the terminal function connection transmitting/receiving unit 31 and the physical port transmitting/receiving unit 21-n, as illustrated in FIG. 2. When generating the N count of logical paths 41-1 to 41-N, the proxy-side logical path transmitting/receiving unit 32 imparts, to the N count of logical paths 41-1 to 41-N, the same logical path identification information as the logical path identification information that the terminal-side logical path transmitting/receiving unit 23 imparted to each when generating the logical paths 41-1 to 41-N.

For example, each time the terminal-side logical path transmitting/receiving unit 23 generates logical paths between itself and the proxy-side logical path transmitting/receiving unit 32, the terminal-side logical path transmitting/receiving unit 23 transmits the logical path identification information imparted to the generated logical paths to the proxy-side logical path transmitting/receiving unit 32. Thus, the terminal-side logical path transmitting/receiving unit 23 and the proxy-side logical path transmitting/receiving unit 32 can share the same logical path identification information for the same logical paths.

Upon receiving a packet from the terminal-side logical path transmitting/receiving unit 23 through one of the logical paths 41-1 to 41-N, the proxy-side logical path transmitting/receiving unit 32 correlates this packet with information identifying the physical port transmitting/receiving unit 21-1 to 21-N corresponding to the receiving logical path 41-1 to 41-N, such as physical port identification information for example, and outputs the information to the proxy transfer processing unit 35 along with the packet. Also, upon receiving a packet correlated with specification information specifying the logical path 41-1 to 41-N to use for transfer from the proxy transfer processing unit 35, the proxy-side logical path transmitting/receiving unit 32 transmits this packet to the terminal-side logical path transmitting/receiving unit 23 through the logical path 41-1 to 41-N corresponding to this specification information.

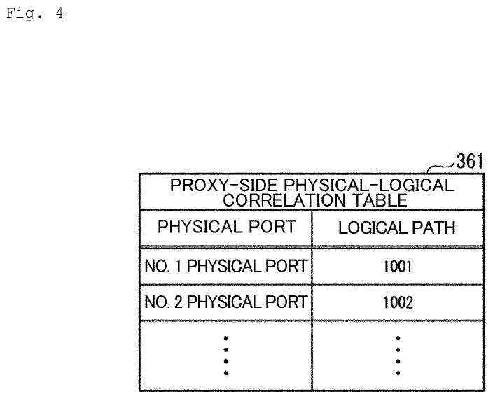

The storage unit 36 stores a proxy-side physical-logical correlation table 361 shown in FIG. 4. The proxy-side physical-logical correlation table 361 is a table with the same contents as the terminal-side physical-logical correlation table 241 shown in FIG. 3 that the storage unit 24 of the terminal function device 2 stores.

For example, when the terminal-side logical path transmitting/receiving unit 23 completes writing of logical path identification information to logical path items corresponding to all physical port items of the terminal-side physical-logical correlation table 241, the terminal-side logical path transmitting/receiving unit 23 transmits data of the terminal-side physical-logical correlation table 241 to the proxy-side logical path transmitting/receiving unit 32. The proxy-side physical-logical correlation table 361 of the same contents as the terminal-side physical-logical correlation table 241 is generated in the storage unit 36 by the proxy-side logical path transmitting/receiving unit 32 receiving the data of the terminal-side physical-logical correlation table 241 and writing to the storage unit 36. Thus, the correlative relation between the physical port transmitting/receiving units 21-1 to 21-N of the terminal function device 2 and the logical paths 41-1 to 41-N can be identified at the proxy transfer agent device 3.

The external NW transmitting/receiving unit 34 connects to an external communication network such as the Internet or the like, for example, and transmits packet received from the proxy transfer processing unit 35 to a device connected to this communication network. Also, upon receiving packets from a device connected to the communication network, the external NW transmitting/receiving unit 34 outputs the received packets to the proxy transfer processing unit 35.

The controller transmitting/receiving unit 33 is connected to a network control device that performs control of a communication network. The network control device here is a device that performs control processing of communication following an SDN protocol such as OpenFlow, P4, or the like, for example. The controller transmitting/receiving unit 33 performs processing of managing exchange of packets between the network control device and the proxy transfer processing unit 35. Processing managed here is, for example, processing of exchanging messages to maintain connection between the proxy transfer agent device 3 and the network control device, processing of converting packets to be transmitted to the network control device in accordance with a message format of the SDN protocol, processing of conversely converting the format of messages received from the network control device into a packet format that the proxy transfer processing unit 35 and the terminal function device 2 can process, processing of exchanging packets including data indicating transfer conditions, transmitted by the network control device, and so forth.

Also, the controller transmitting/receiving unit 33 performs processing of additionally writing values set in advance to messages, with regard to messages for maintaining connection and SDN protocol messages generated by converting packets transmitted to the network control device, following the protocol between itself and the network control device and the message format.

For example, in a case in which the network control device is operating under the OpenFlow protocol, the controller transmitting/receiving unit 33 writes values set in advance to the “datapath-id” and “ports” items of FeatureRes message to be transmitted to the network control device under the OpenFlow protocol. For example, the controller transmitting/receiving unit 33 writes unique identification information imparted in advance to the terminal function device 2 to the item “datapath-id”, and writes data indicating the count and the state of the physical port transmitting/receiving units 21-1 to 21-N of the terminal function device 2 to the item “ports”. Note that assumption will be made that the information relating to the terminal function device 2 that is written to the “datapath-id” and “ports” items is stored in the internal storage region of the controller transmitting/receiving unit 33 in advance. Thus, the OpenFlow network control device recognizes the controller transmitting/receiving unit 33 as a virtual OpenFlow switch in which are reflected characteristics of the terminal function device 2, such as the count and the state of the physical port transmitting/receiving units 21-1 to 21-N and so forth, for example.

Also, the controller transmitting/receiving unit 33 outputs data indicating transfer conditions specified by the network control device, received from the network control device, to the proxy transfer processing unit 35.

The proxy transfer processing unit 35 determines whether or not the packet received from the proxy-side logical path transmitting/receiving unit 32 matches the transfer conditions specified by the network control device received from the controller transmitting/receiving unit 33, and in a case of the packet matching the transfer conditions, the transfer processing set in the transfer conditions is performed regarding the packet, and the packet is output to the controller transmitting/receiving unit 33. Also, in a case of the packet received from the proxy-side logical path transmitting/receiving unit 32 not matching the transfer conditions, the proxy transfer processing unit 35 performs transfer processing set in advance regarding the packet, and outputs the packet to the external NW transmitting/receiving unit 34. Note that the proxy transfer processing unit 35 may, regardless of matching transfer conditions or not, transfer the packet to the controller transmitting/receiving unit 33, or transfer the packet to the external NW transmitting/receiving unit 34.

Now, the transfer processing that the proxy transfer processing unit 35 performs is complicated processing in comparison to the transfer processing that the transfer processing unit 22 of the terminal function device 2 described above performs, and includes processing such as, for example rewriting part of data included in packets, deleting part of the data, and so forth. Specific transfer processing is as follows. A packet attached with a VLAN tag that has been sent out is received by the proxy-side logical path transmitting/receiving unit 32 of the proxy transfer agent device 3. Thereafter, the packet attached with the VLAN tag has the VLAN tag deleted by the proxy-side logical path transmitting/receiving unit 32, and subsequently is sent to the proxy transfer processing unit 35 along with information indicating that the aforementioned packet was received at the No. 1 physical port of the terminal function device 2. The proxy transfer processing unit 35 sends this packet to the controller transmitting/receiving unit 33 as stipulated, on the basis of the information that the packet sent from the proxy-side logical path transmitting/receiving unit 32 was received at the No. 1 physical port. The controller transmitting/receiving unit 33 converts this packet into an OpenFlow packet-in message format, and thereupon transfers to an OpenFlow controller. At this time, the aforementioned port information (information indicating the No. 1 physical port) is written to the OFPXMT_OFB_IN_PHY_PORT of the packet-in message. Also, values set in advance are written to other items of the packet-in message.

Also, upon receiving a packet from the controller transmitting/receiving unit 33 or the external NW transmitting/receiving unit 34, the proxy transfer processing unit 35 performs transfer processing set in advance with regard to the received packet, and outputs the packet to the proxy-side logical path transmitting/receiving unit 32. When outputting the packet to the proxy-side logical path transmitting/receiving unit 32, the proxy transfer processing unit 35 correlates this packet with specification information specifying the logical path 41-1 to 41-N to serve as the transfer route of the packet, and outputs the specification information to the proxy-side logical path transmitting/receiving unit 32 along with the packet.

Physical port identification information, for example, is applied as this specification information, and the specification information is generated by the proxy transfer processing unit 35 on the basis of information that the controller transmitting/receiving unit 33 outputs to the proxy transfer processing unit 35, or information that the external NW transmitting/receiving unit 34 outputs to the proxy transfer processing unit 35, or information included in the packet, or the like.

The packet transfer system 1 according to the above basic embodiment is provided with the terminal function device 2 and the proxy transfer agent device 3, and in the terminal function device 2, the physical port transmitting/receiving units 21-1 to 21-N perform transmission and reception of packets through the physical lines 4-1 to 4-N respectively connected thereto. The transfer processing unit 22 is connected to each of the physical port transmitting/receiving units 21-1 to 21-N and performs transfer processing of packets output by the physical port transmitting/receiving units 21-1 to 21-N or packets output to the physical port transmitting/receiving units 21-1 to 21-N. The terminal-side logical path transmitting/receiving unit 23 generates the logical paths 41-1 to 41-N to be correlated to the physical port transmitting/receiving units 21-1 to 21-N at any physical line 4-n, and in a case of receiving a packet from the transfer processing unit 22, sends out this packet to the logical path 41-1 to 41-N corresponding to the physical port transmitting/receiving unit 21-1 to 21-N that received the packet, and in a case of receiving the packet through a logical path 41-1 to 41-N, specifies the physical port transmitting/receiving unit 21-1 to 21-N corresponding to the logical path 41-1 to 41-N that received the packet as the transfer destination thereof, and outputs the packet to the transfer processing unit 22 . In the proxy transfer agent device 3, the proxy-side logical path transmitting/receiving unit 32 generates the logical paths 41-1 to 41-N on the physical line 4-n connecting to the terminal function device 2, and in a case of receiving a packet through the logical paths 41-1 to 41-N, corelates the packet with information identifying the physical port transmitting/receiving unit 21-1 to 21-N corresponding to the logical path 41-1 to 41-N that received the packet, and outputs the information along with this packet, and in a case of sending out a packet to a logical path 41-1 to 41-N, sends out the packet to the logical path 41-1 to 41-N corresponding to the physical port transmitting/receiving unit 21-1 to 21-N specified as the transfer destination of this packet.

Accordingly, the proxy transfer agent device 3 can be notified of the information identifying the physical port transmitting/receiving unit 21-1 to 21-N of the packet recipient, by exchanging packets through the logical paths 41-1 to 41-N that correspond in a one-on-one manner to the physical port transmitting/receiving units 21-1 to 21-N, and that are generated between the terminal function device 2 and the proxy transfer agent device 3. Accordingly, the network control device connected to the proxy transfer agent device 3 can reference information identifying the physical port transmitting/receiving units 21-1 to 21-N. Also, the proxy transfer agent device 3 can transmit packets to the terminal function device 2, with the physical port transmitting/receiving unit 21-1 to 21-N sending out packets at the terminal function device 2 specified.

In this case, the configuration added to the terminal function device 2 is no more than the configuration for generating the logical paths 41-1 to 41-N that correspond in a one-on-one manner to the physical port transmitting/receiving units 21-1 to 21-N, and there is no need to add complicated transfer processing that directly notifies the network control device of information identifying the physical port transmitting/receiving unit 21-1 to 21-N of the packet recipient. Accordingly, in a case of employing a split architecture separated into central functions and terminal functions, new communication protocols such as SDN and so forth can be flexibly added without adding high-level transfer processing to the terminal function device.

### First Embodiment

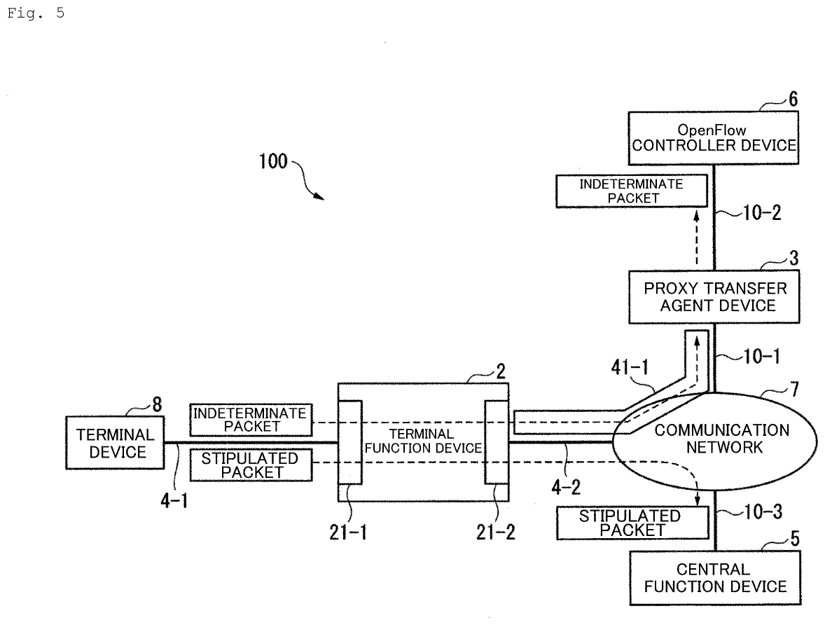

FIG. 5 is a block diagram illustrating a configuration of a communication system 100 that uses the packet transfer system 1 described in the basic embodiment. The communication system 100 is provided with the terminal function device 2, the proxy transfer agent device 3, a central function device 5, an OpenFlow controller device 6, a communication network 7, and a terminal device 8. Note that FIG. 5 illustrates a case of N=2, i.e., a configuration in which the terminal function device 2 is provided with two physical port transmitting/receiving units 21-1 and 21-2, with the terminal-side logical path transmitting/receiving unit 23 connected to the physical port transmitting/receiving unit 21-2. The terminal device 8 is a device that transmits and receives packets under user operations, and is connected to the other end of the physical line 4-1 connecting to the physical port transmitting/receiving unit 21-1 of the terminal function device 2.

The physical port transmitting/receiving unit 21-2 of the terminal function device 2 connects to the communication network 4 via the physical line 4-2. The central function device 5 is a device that performs DBA (Dynamic Bandwidth Allocation) processing and so forth of a PON (Passive Optical Network), for example, and connects to the communication network 7 via a physical line 10-3. The terminal function connection transmitting/receiving unit 31 of the proxy transfer agent device 3 connects to the communication network 7 via a physical line 10-1.

The communication network 7 connects the physical port transmitting/receiving unit 21-2, the central function device 5, and the terminal function connection transmitting/receiving unit 31 to each other. Note that the communication network 4 is a communication network separate from the external communication network to which the external NW transmitting/receiving unit 34 of the proxy transfer agent device 3 connects, and is a communication network that performs closed communication between the terminal function device 2, and the proxy transfer agent device 3 and the central function device 5.

The controller transmitting/receiving unit 33 of the proxy transfer agent device 3 connects to the OpenFlow controller device 6 via a physical line 10-2. The OpenFlow controller device 6 is a device that corresponds to the network control device shown in the basic embodiment, running on the OpenFlow 1.3 protocol for example, and exchanging messages of a format stipulated by this protocol with the proxy transfer agent device 3.

The terminal-side logical path transmitting/receiving unit 23 of the terminal function device 2 and the proxy-side logical path transmitting/receiving unit 32 of the proxy transfer agent device 3 generate two logical paths 41-1 and 41-2 via the physical line 4-2, the communication network 7, and the physical line 10-1. Note that in FIG. 5, only the logical path 41-1 corresponding to the physical port transmitting/receiving unit 21-1 is illustrated, for the sake of convenience of description.

Assumption will be made here that the terminal-side logical path transmitting/receiving unit 23 and the proxy-side logical path transmitting/receiving unit 32 generate the logical paths 41-1 and 41-2 by VLAN, as one example. The terminal-side logical path transmitting/receiving unit 23 and the proxy-side logical path transmitting/receiving unit 32 generate a VLAN-ID “1001” as logical path identification information and impart this to the logical path 41-1, and generate a VLAN-ID “1002” as logical path identification information and impart this to the logical path 41-2.

The terminal-side logical path transmitting/receiving unit 23 writes “1001” to the “logical path” item corresponding to the No. 1 physical port in the terminal-side physical-logical correlation table 241 in the storage unit 24, and writes “1002” to the “logical path” item corresponding to the No. 2 physical port. Thus, the terminal-side physical-logical correlation table 241 including the records of the first row and the second row, illustrated in FIG. 3, is generated in the storage unit 24. In the same way, the proxy-side physical-logical correlation table 361 including the records of the first row and the second row, illustrated in FIG. 4, is generated in the storage unit 36 as well.

(Packet-In Processing in First Embodiment)

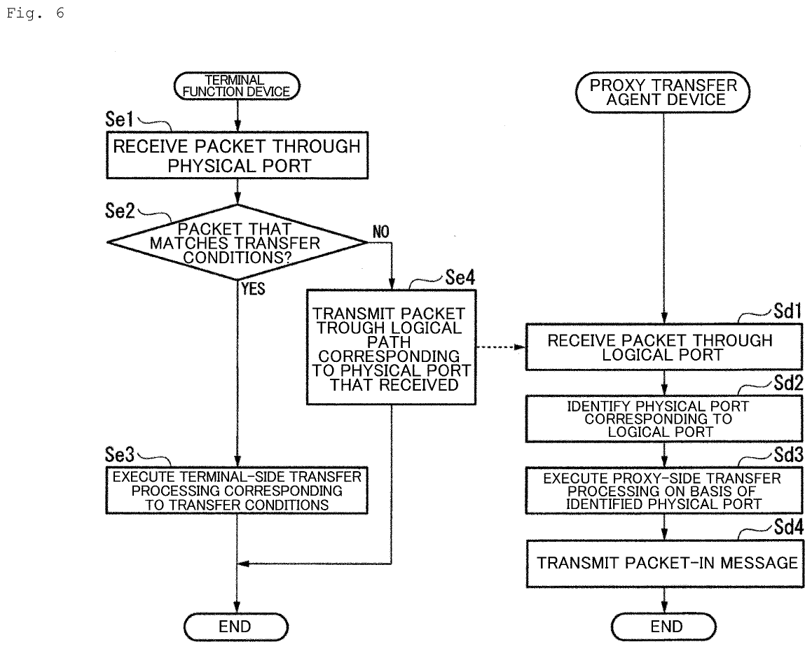

FIG. 6 is a flowchart showing the flow of processing in a case in which packet-in processing in the OpenFlow protocol is performed. Packet-in is processing in which an OpenFlow switch transmits a packet to an OpenFlow controller, and in the case of the communication system 100 illustrated in FIG. 5, this is processing of the proxy transfer agent device 3, which the OpenFlow controller device 6 recognizes as being an OpenFlow switch, transmitting a packet to the OpenFlow controller device 6.

The OpenFlow controller device 6 transmits, to the controller transmitting/receiving unit 33 of the proxy transfer agent device 3 in advance, data indicating transfer conditions for packet-in of the packet received at the physical port transmitting/receiving unit 21-1 of the terminal function device 2. Upon receiving the data indicating the transfer conditions from the OpenFlow controller device 6, the controller transmitting/receiving unit 33 outputs the received data indicating the transfer conditions to the proxy transfer processing unit 35. The proxy transfer processing unit 35 takes in the data indicating the transfer conditions output from the controller transmitting/receiving unit 33, and stores the data in the internal storage region.

Conditions of transferring to the physical port transmitting/receiving unit 21-2 in a case in of packets of types that are processed by the central function device 5, are assumed to be set in advance as transfer conditions for the transfer processing unit 22 of the terminal function device 2. Hereinafter, packets of types that are processed by the central function device 5 will be referred to as stipulated packets.

The terminal device 8 sends out a packet to the physical line 4-1. The physical port transmitting/receiving unit 21-1 of the terminal function device 2 receives the packet through the physical line 4-1 (step Se1). The physical port transmitting/receiving unit 21-1 outputs the received packet to the transfer processing unit 22. Upon taking in the packet output by the physical port transmitting/receiving unit 21-1, the transfer processing unit 22 determines whether or not the packet that has been taken in matches the transfer conditions, on the basis of the transfer conditions set in advance (step Se2).

If the packet that the terminal device 8 has sent out is a stipulated packet, the transfer processing unit 22 determines that the packet that has been taken in matches the transfer conditions (step Se2, Yes), and performs transfer processing set in these transfer conditions, i.e., processing of transferring the packet that has been taken in to the physical port transmitting/receiving unit 21-2 (step Se3). The physical port transmitting/receiving unit 21-2 takes in the stipulated packet that the transfer processing unit 22 outputs, and sends out the stipulated packet that has been taken in to the physical line 4-2. Thus, the stipulated packet is transferred to the central function device 5 by the communication network 7.

Conversely, in a case in which the packet that the terminal device 8 has sent out is not a stipulated packet but an indeterminate packet, the transfer processing unit 22 determines that the packet that has been taken in does not match the transfer conditions (step Se2, No), correlates the packet with physical port identification information of the physical port transmitting/receiving unit 21-1 that took in this packet, i.e., the “No. 1 physical port”, and performs output thereof to the terminal-side logical path transmitting/receiving unit 23 along with the packet.

The terminal-side logical path transmitting/receiving unit 23 takes in the packet that the transfer processing unit 22 outputs, and the physical port identification information “No. 1 physical port” correlated with the packet. The terminal-side logical path transmitting/receiving unit 23 references the terminal-side physical-logical correlation table 241 of the storage unit 24, and reads out the logical path identification information “1001” corresponding to the physical port identification information “No. 1 physical port”. The terminal-side logical path transmitting/receiving unit 23 takes the “1001” that is read out as the VALN-ID, which is attached as a VLAN tag to the packet, and transmits the packet to the proxy transfer agent device 3 through the logical path 41-1 (step Se4).

The proxy-side logical path transmitting/receiving unit 32 of the proxy transfer agent device 3 receives the packet through the logical path 41-1 (Step Sd1). The proxy-side logical path transmitting/receiving unit 32 deletes the VLAN tag “1001” attached to the received packet. The proxy-side logical path transmitting/receiving unit 32 references the proxy-side physical-logical correlation table 361 in the storage unit 36, and reads out the physical port identification information “No. 1 physical port” corresponding to the logical path identification information “1001” (step Sd2).

The proxy-side logical path transmitting/receiving unit 32 correlates the physical port identification information “No. 1 physical port” that has been read out with the packet, and outputs the information to the proxy transfer processing unit 35 along with the packet. The proxy transfer processing unit 35 takes in the packet that the proxy-side logical path transmitting/receiving unit 32 outputs, and the physical port identification information “No. 1 physical port” correlated with the packet.

The proxy transfer processing unit 35 references transfer conditions stored in the internal storage region, i.e., transfer conditions for packet-in of the packet received at the physical port transmitting/receiving unit 21-1 of the terminal function device 2. The physical port identification information correlated with the packet that has been taken in is “No. 1 physical port”, i.e., matches the physical port transmitting/receiving unit 21-1, and accordingly the proxy transfer processing unit 35 outputs the packet and the physical port identification information “No. 1 physical port” to the controller transmitting/receiving unit 33 (step Sd3).

The controller transmitting/receiving unit 33 takes in the packet output by the proxy transfer processing unit 35 and the physical port identification information “No. 1 physical port”. The controller transmitting/receiving unit 33 converts the packet that has been taken in into an OpenFlow packet-in message format, and generates a packet-in message. The controller transmitting/receiving unit 33 writes the physical port identification information “No. 1 physical port” that has been taken in into the OFPXMT_OFB_IN_PYH_PORT item of the generated packet-in message, and writes values set in advance to the other items as well. Upon writing of data and values to the items being completed, the controller transmitting/receiving unit 33 transmits the packet-in message to the OpenFlow controller device 6 through the physical line 10-2 (step Sd4). The OpenFlow controller device 6 receives the packet-in message through the physical line 10-2.

(Packet-Out Processing in First Embodiment)

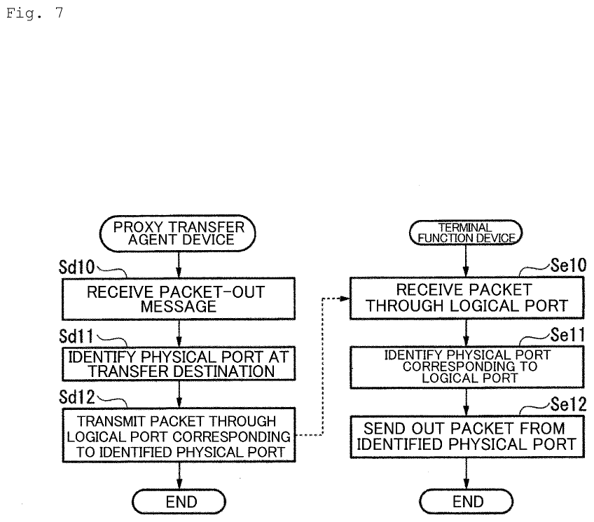

FIG. 7 is a flowchart showing the flow of packet-out processing, i.e., processing of the OpenFlow controller device 6 transmitting a packet to the proxy transfer agent device 3 that is recognized to be an OpenFlow switch by the OpenFlow controller device 6 in the communication system 100 illustrated in FIG. 5. Processing that is reverse to the packet-in processing shown in FIG. 6 is performed in the processing shown in FIG. 7.

Assumption will be made that transfer conditions are set in advance so that the proxy transfer processing unit 35 transfers a packet received from the controller transmitting/receiving unit 33 or the external NW transmitting/receiving unit 34 to the proxy-side logical path transmitting/receiving unit 32.

The OpenFlow controller device 6 generates an OpenFlow packet-out message, instructing a packet to be sent out from the physical port transmitting/receiving unit 21-1 of the terminal function device 2. The OpenFlow controller device 6 writes the physical port identification information “No. 1 physical port” identifying the physical port transmitting/receiving unit 21-1 that is the transfer destination of the packet in the terminal function device 2, to the relevant item in the generated OpenFlow packet-out message, and transmits the packet-out message to the proxy transfer agent device 3 through the physical line 10-2.

The controller transmitting/receiving unit 33 of the proxy transfer agent device 3 receives the packet-out message through the physical line 10-2 (step Sd10). The controller transmitting/receiving unit 33 reads out the physical port identification information “No. 1 physical port” included in the received packet-out message (step Sd11). The controller transmitting/receiving unit 33 converts the packet-out message into a format that the terminal function device 2 is capable of processing and generates a package, correlates the generated packet with the physical port identification information “No. 1 physical port”, and outputs the information to the proxy transfer processing unit 35 along with the packet.

The proxy transfer processing unit 35 takes in the packet output by the controller transmitting/receiving unit 33, and the physical port identification information “No. 1 physical port” correlated with this packet. The proxy transfer processing unit 35 references the transfer conditions set in advance, i.e., the transfer conditions that packets output by the controller transmitting/receiving unit 33 are transferred to the proxy-side logical path transmitting/receiving unit 32. The proxy transfer processing unit 35 determines that the transfer conditions are matched, since the packet that is taken in is a packet that has been output by the controller transmitting/receiving unit 33, correlates the physical port identification information “No. 1 physical port” with the packet as specification information, and outputs the information to the proxy-side logical path transmitting/receiving unit 32 along with the packet.

The proxy-side logical path transmitting/receiving unit 32 takes in the packet output by the proxy transfer processing unit 35, and the specification information correlated with the packet. The proxy-side logical path transmitting/receiving unit 32 references the proxy-side physical-logical correlation table 361 in the storage unit 36, and reads out the logical path identification information “1001” corresponding to the specification information, i.e., corresponding to the physical port identification information “No. 1 physical port”. The proxy-side logical path transmitting/receiving unit 32 takes the “1001” that is read out as a VALN-ID, which is attached to the packet as a VLAN tag, and transmits the packet to the terminal function device 2 through the logical path 41-1 (step Sd12).

The terminal-side logical path transmitting/receiving unit 23 of the terminal function device 2 receives the packet through the logical path 41-1 (step Se10) . The terminal-side logical path transmitting/receiving unit 23 deletes the VLAN tag “1001” attached to the received packet. The terminal-side logical path transmitting/receiving unit 23 references the terminal-side physical-logical correlation table 241 in the storage unit 24, and reads out the physical port identification information “No. 1 physical port” corresponding to the logical path identification information “1001” (step Se11).

The terminal-side logical path transmitting/receiving unit 23 takes the physical port identification information “No. 1 physical port” that is read out as specification information, correlates the specification information with the packet, and outputs the information to the transfer processing unit 22 along with the packet. The transfer processing unit 22 takes in the packet output by the terminal-side logical path transmitting/receiving unit 23, and the specification information correlated with the packet.

On the basis of the specification information taken in, i.e., the physical port identification information “No. 1 physical port”, the transfer processing unit 22 transfers the packet that has been taken in to the physical port transmitting/receiving unit 21-1 corresponding to the “No. 1 physical port”. The physical port transmitting/receiving unit 21-1 takes in the packet output by the transfer processing unit 22, and sends out the packet that has been taken in to the physical line 4-1 (step Se12). The packet is transmitted by the physical line 4-1, and the terminal device 8 receives the packet through the physical line 4-1.

According to the configuration of the above first embodiment, packet-in and packet-out processing according to the OpenFlow protocol can be performed even in a case of employing a split architecture separated into central functions and terminal functions, by being provided with the packet transfer system 1, i.e., the terminal function device 2 and the proxy transfer agent device 3.

### Second Embodiment

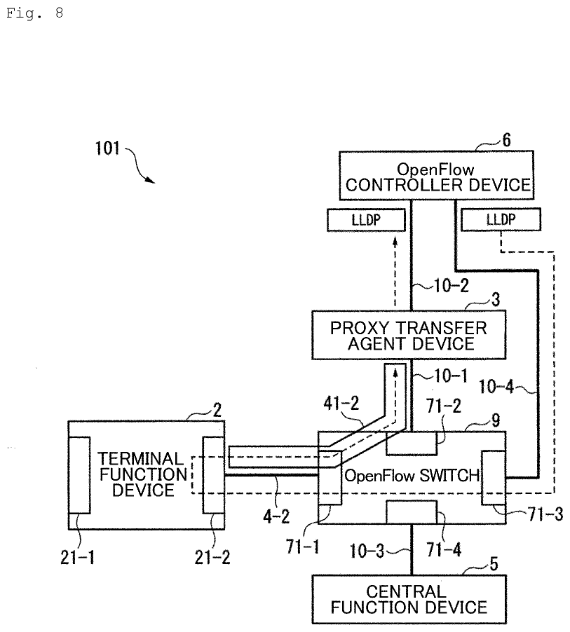

FIG. 8 is a block diagram illustrating a configuration of the configuration of a communication system 101 that uses the packet transfer system 1 described in the basic embodiment. Note that in the second embodiment, configurations that are the same as configurations in the basic embodiment and the first embodiment are denoted by the same signs.

The communication system 101 has a configuration in which the communication network 7 of the communication system 100 illustrated in FIG. 5 is replaced by an OpenFlow switch 9, and further, the OpenFlow controller device 6 and the OpenFlow switch 9 are connected by a physical line 10-4.

The communication system 101 is provided with the terminal function device 2, the proxy transfer agent device 3, the central function device 5, the OpenFlow controller device 6, and the OpenFlow switch 9. The OpenFlow switch 9 is provided with four physical ports 71-1 to 71-4, and performs packet transfer on the basis of the OpenFlow protocol.

At the OpenFlow switch 9, the physical port 71-1 connects to the physical port transmitting/receiving unit 21-2 of the terminal function device 2 via the physical line 4-2. The physical port 71-2 connects to the terminal function connection transmitting/receiving unit 31 of the proxy transfer agent device 3 via the physical line 10-1. The physical port 71-3 connects to the OpenFlow controller device 6 via the physical line 10-4. The physical port 71-4 connects to the central function device 5 via the physical line 10-3.

In the communication system 101 as well, in a case of N=2, i.e., the terminal function device 2 is provided with two physical port transmitting/receiving units 21-1 and 21-2, with the terminal-side logical path transmitting/receiving unit 23 connected to the physical port transmitting/receiving unit 21-2, in the same way as in the communication system 100. The terminal-side logical path transmitting/receiving unit 23 of the terminal function device 2 and the proxy-side logical path transmitting/receiving unit 32 of the proxy transfer agent device 3 generate two logical paths 41-1 and 41-2 via the physical line 4-2, the OpenFlow switch 9, and the physical line 10-1. Note that in FIG. 8, only the logical path 41-2 corresponding to the physical port transmitting/receiving unit 21-2 is illustrated, for the sake of convenience of description.

Assumption will be made in the communication system 101 as well that the terminal-side logical path transmitting/receiving unit 23 and the proxy-side logical path transmitting/receiving unit 32 generate logical paths 41-1 and 41-2 by VLAN, in the same way as with the communication system 100. The terminal-side logical path transmitting/receiving unit 23 and the proxy-side logical path transmitting/receiving unit 32 generate a VLAN-ID “1001” as logical path identification information and impart this to the logical path 41-1, and generate a VLAN-ID “1002” as logical path identification information and impart this to the logical path 41-2.

The terminal-side logical path transmitting/receiving unit 23 writes “1001” to the “logical path” item corresponding to the No. 1 physical port in the terminal-side physical-logical correlation table 241 in the storage unit 24, and writes “1002” to the “logical path” item corresponding to the No. 2 physical port. Thus, the terminal-side physical-logical correlation table 241 including the records of the first row and the second row, illustrated in FIG. 3, is generated in the storage unit 24. In the same way, the proxy-side physical-logical correlation table 361 including the records of the first row and the second row, illustrated in FIG. 4, is generated in the storage unit 36 as well.

(Detection Processing of Connection Relation of Adjacent Switches in Second Embodiment)

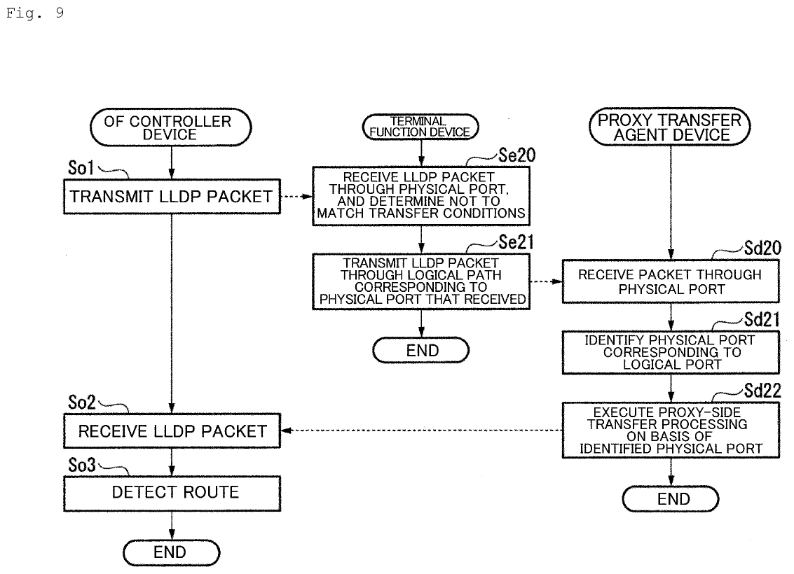

Processing of the OpenFlow controller device 6 detecting the connection relation between adjacent switches by LLDP (Link Layer Discovery Protoco) in the OpenFlow protocol, i.e., between the terminal function device 2 and the OpenFlow switch 9, will be described below on the basis of the communication system 101 illustrated in FIG. 8. FIG. 9 is a flowchart showing the flow of this processing.

The OpenFlow controller device 6 transmits, to the controller transmitting/receiving unit 33 of the proxy transfer agent device 3 in advance, data indicating transfer conditions for packet-in of an LLDP packet. Upon receiving the data indicating the transfer conditions, the controller transmitting/receiving unit 33 outputs the received data to the proxy transfer processing unit 35, the proxy transfer processing unit 35 takes in the data indicating the transfer conditions, and stores the data in the internal storage region.

Conditions of transferring to the physical port transmitting/receiving unit 21-2 in a case of packets of types that are processed by the central function device 5, are assumed to be set in advance as transfer conditions for the transfer processing unit 22 of the terminal function device 2.

The OpenFlow controller device 6 generates an LLDP packet including, as a Chassis ID, information identifying the OpenFlow switch 9, such as a Datapath ID or the like, for example, and including information identifying the physical port 71-1 as a Port ID, and sends out the generated LLDP packet to the physical line 10-4 by a packet-out message (step So1). Note that this packet-out message is assumed to include action information of transferring the LLDP packet to the physical port 71-1 of the OpenFlow switch 9.

The OpenFlow switch 9 takes in the packet-out message received at the physical port 71-3. The OpenFlow switch 9 sends out the LLDP packet included in the packet-out message to the physical line 4-2 connected to the physical port 71-1, in accordance with the action information included in the packet-out message that has been taken in.

The physical port transmitting/receiving unit 21-2 of the terminal function device 2 receives the LLDP packet through the physical line 4-2, and outputs the received LLDP packet to the transfer processing unit 22. The transfer processing unit 22 only has conditions of transferring packets of types processed at the central function device 5 as the transfer conditions, as described above, and accordingly determines that the LLDP packet output by the physical port transmitting/receiving unit 21-2 is a packet that does not match the transfer conditions (step Se20).

The LLDP packet is a packet that does not match the transfer conditions, and accordingly the transfer processing unit 22 correlates physical port identification information “No. 2 physical port” of the physical port transmitting/receiving unit 21-2 that has received this packet with the LLDP packet, and outputs the information to the terminal-side logical path transmitting/receiving unit 23 along with the LLDP packet.

The terminal-side logical path transmitting/receiving unit 23 takes in the LLDP packet output by the transfer processing unit 22 and the physical port identification information “No. 2 physical port” correlated with the LLDP packet. The terminal-side logical path transmitting/receiving unit 23 references the terminal-side physical-logical correlation table 241 in the storage unit 24, and reads out the logical path identification information “1002” corresponding to the physical port identification information “No. 2 physical port”. The terminal-side logical path transmitting/receiving unit 23 takes the “1002” that has been read out as a VALN-ID and attaches to the LLDP packet as a VLAN tag, and transmits the LLDP packet to the proxy transfer agent device 3 through the logical path 41-2 (step Se21).

The proxy-side logical path transmitting/receiving unit 32 of the proxy transfer agent device 3 receives the LLDP packet through the logical path 41-2 (step Sd20). The proxy-side logical path transmitting/receiving unit 32 deletes the VLAN tag “1002” attached to the received LLDP packet. The proxy-side logical path transmitting/receiving unit 32 references the proxy-side physical-logical correlation table 361 in the storage unit 36, and reads out the physical port identification information “No. 2 physical port” corresponding to the logical path identification information “1002” (step Sd21).

The proxy-side logical path transmitting/receiving unit 32 correlates the physical port identification information “No. 2 physical port” that has been read out with the packet, and outputs the information to the proxy transfer processing unit 35 along with the LLDP packet. The proxy transfer processing unit 35 takes in the LLDP packet output by the proxy-side logical path transmitting/receiving unit 32, and the physical port identification information “No. 2 physical port” correlated with the LLDP packet.

The transfer conditions stored in the internal storage region are conditions to perform packet-in of LLDP packets, and accordingly the proxy transfer processing unit 35 determines that the transfer conditions are matched, and outputs the LLDP packet that has been taken in and the physical port identification information “No. 2 physical port” to the controller transmitting/receiving unit 33.

The controller transmitting/receiving unit 33 takes in the LLDP packet output by the proxy transfer processing unit 35 and the physical port identification information “No. 2 physical port”. The controller transmitting/receiving unit 33 converts the LLDP packet that has been taken in into the OpenFlow packet-in message format, and generates a packet-in message. The controller transmitting/receiving unit 33 writes the physical port identification information “No. 2 physical port” that has been taken in into the OFPXMT_OFB_IN_PYH_PORT item of the generated packet-in message, and writes values set in advance to the other items as well. Upon writing of data and values to the items being completed, the controller transmitting/receiving unit 33 sends out the packet-in message to the physical line 10-2 (step Sd22).

The OpenFlow controller device 6 receives the packet-in message through the physical line 10-2 (step So2). The OpenFlow controller device 6 reads out the physical port identification information “No. 2 physical port” included in the packet-in message. The OpenFlow controller device 6 detects that the physical port 71-1 of the OpenFlow switch 9 and the No. 2 physical port of the terminal function device 2, i.e., the physical port transmitting/receiving unit 21-2, are in an adjacent connection relation, on the basis of the information identifying the OpenFlow switch 9 set in the Chassis ID at the time of packet-out of the LLDP packet, information identifying the physical port 71-1 set to the Port ID, and the physical port identification information “No. 2 physical port” that has been read out (step So3).

According to the configuration of the above second embodiment, topology detection using LLDP packets of the OpenFlow protocol can be performed even in a case of employing a split architecture separated into central functions and terminal functions, by being provided with the packet transfer system 1, i.e., the terminal function device 2 and the proxy transfer agent device 3.

The proxy transfer agent device 3 may transfer a packet received from a certain logical path of the proxy-side logical path transmitting/receiving unit 32 to another logical path. Note however, that when transferring, there is a need for the proxy transfer processing unit 35 to convert the packet into a format that the terminal function device 2 is capable of processing.

Also, in the above first embodiment and second embodiment, examples are illustrated in which the proxy transfer agent device 3 and the central function device 5 are configured as separate devices, as illustrated in FIG. 5 and FIG. 8, but the configuration of the present invention is not limited to these embodiments. The proxy transfer agent device 3 and the central function device 5 may be configured as an integrated device. Note however, that in a case in which the central function device 5 performs processing that is sensitive with regard to delay or jittering, configuring as separate devices as illustrated in FIG. 5 and FIG. 8 enables concentration of packets at the central function device 5 to be prevented, and accordingly effects of suppressed performance deterioration of the central function device 5 can be anticipated.

Also, in the above basic embodiment, first embodiment, and second embodiment, the terminal-side logical path transmitting/receiving unit 23 and the proxy-side logical path transmitting/receiving unit 32 generate an N count of logical paths 41-1 to 41-N corresponding to the N count of physical port transmitting/receiving units 21-1 to 21-N of the terminal function device 2 in a one-on-one manner. However, the present invention is not limited to these embodiments. As shown in the first and second embodiments, there are cases in which only one of the logical paths 41-1 and 41-2 is used, and taking such cases into consideration, an arrangement may be made where the terminal-side logical path transmitting/receiving unit 23 and the proxy-side logical path transmitting/receiving unit 32 dynamically generate the logical paths 41-1 to 41-N as necessary.

Also, in the above basic embodiment, first embodiment, and second embodiment, the terminal-side logical path transmitting/receiving unit 23 generates logical path identification information, and transmits the generated logical path identification information to the proxy-side logical path transmitting/receiving unit 32, whereby the terminal-side logical path transmitting/receiving unit 23 and the proxy-side logical path transmitting/receiving unit 32 impart the same logical path identification information to the same logical path. However, the configuration of the present invention is not limited to these embodiments. Conversely, an arrangement may be made in which the proxy-side logical path transmitting/receiving unit 32 generates logical path identification information, and transmits the generated logical path identification information to the terminal-side logical path transmitting/receiving unit 23.

Also, for example, in a case in which the logical path identification information is a numerical value, a rule may be set between the terminal-side logical path transmitting/receiving unit 23 and the proxy-side logical path transmitting/receiving unit 32 to have an initial value set, and to generate logical path identification information by incrementing one at a time, each time one logical path 41-1 to 41-N is generated. Thus, both of the terminal-side logical path transmitting/receiving unit 23 and the proxy-side logical path transmitting/receiving unit 32 can impart the same logical path identification information to the same logical path 41-1 to 41-N, without exchanging the logical path identification information generated thereby with each other as described above.

Also, a correlative relation between the physical port identification information of the physical port transmitting/receiving units 21-1 to 21-N and the logical path identification information may be set in advance, so that the terminal-side physical-logical correlation table 241 and the proxy-side physical-logical correlation table 361 of the same contents including information of this correlative relation are generated, and respectively stored in the storage unit 24 and the storage unit 36 in advance, for example. In this case, the terminal-side logical path transmitting/receiving unit 23 and the proxy-side logical path transmitting/receiving unit 32 each reference the respectively-corresponding terminal-side physical-logical correlation table 241 and the proxy-side physical-logical correlation table 361, and impart logical path identification information in order from the recording in the first row for the generated logical path, for example, and thereby can impart the same logical path identification information to the same logical path. Accordingly, the correlative relation between the physical port transmitting/receiving units 21-1 to 21-N and the logical paths 41-1 to 41-N can be shared between the terminal function device 2 and the proxy transfer agent device 3.

Also, in the above basic embodiment, first embodiment, and second embodiment, description has been made regarding an example in which packets are the object of transfer, but the object of transfer does not need to be limited to packets. For example, signals exchanged over a wireless access network (e.g., physical signals, etc.) may be used other than packets.

The terminal function device 2 and the proxy transfer agent device 3 in the above-described embodiments may be realized by a computer. In this case, these may be realized by recording a program for realizing these functions in a computer-readable recording medium, and causing a computer system to read and execute the program recorded in this recording medium. Note that “computer system” as used here includes an OS and hardware such as peripheral equipment and so forth. Also, “computer-readable recording medium” refers portable media such as flexible disks, magneto-optical discs, ROM, CD-ROM, and so forth, and storage devices such as hard disks and the like built into the computer system. Further, “computer-readable recording medium” may include arrangements that dynamically hold the program for a short period of time, such as a network such as the Internet or the like, or a communication wire in a case of transmitting the program over a communication line such as a telephone line or the like, or an arrangement in which the program is held for a certain amount of time, as with volatile memory within the computer system serving as a server or a client in this case. Also, the above program may be for realizing part of the above-described functions, and further the above-described functions may be realized by combination with a program already recorded in the computer system, and may be realized using a programmable logic device such as an FPGA (Field Programmable Gate Array) or the like.

Although embodiments of this invention have been described above in detail with reference to the Figures, specific configurations are not limited to these embodiments, and designs and so forth of a scope not departing from the essence of this invention are also included.

### INDUSTRIAL APPLICABILITY

Usable when applying the SDN protocol to a split-type communication control device in which the C-Plane and U-Plane are separated.

### REFERENCE SIGNS LIST

1 Packet transfer system
2 Terminal function device
3 Proxy transfer agent device
4-1 to 4-N Physical lines
21-1 to 21-N Physical port transmitting/receiving units
22 Transfer processing unit
23 Terminal-side logical path transmitting/receiving unit
24 Storage unit
31 Terminal function connection transmitting/receiving unit
32 Proxy-side logical path transmitting/receiving unit
33 Controller transmitting/receiving unit
34 External NW transmitting/receiving unit
35 Proxy transfer processing unit
36 Storage unit

1. A signal transfer system, comprising:
a terminal function device, including
a plurality of physical port transmitting/receiving units that perform transmission/reception of signals through physical lines respectively connected thereto,
a transfer processing unit that connects to each of the physical port transmitting/receiving units and that performs transfer processing of signals output by the physical port transmitting/receiving unit, or signals output to the physical port transmitting/receiving units, and
a terminal-side logical path transmitting/receiving unit that generates a logical path to be the physical port transmitting/receiving unit on one of the physical lines, and that, in a case of receiving a signal from the transfer processing unit, sends out the signal to a logical path corresponding to the physical port transmitting/receiving unit that received this signal, and in a case of receiving a signal through the logical path, outputs the signal to the transfer processing unit with the physical port transmitting/receiving unit corresponding the logical path that received this signal specified as a transfer destination thereof; and
a proxy transfer agent device, including
a proxy-side logical path transmitting/receiving unit that, together with the terminal function device, generates the logical paths to be correlated with the physical port transmitting/receiving units, and that, in a case of receiving a signal through the logical paths, correlates information identifying the physical port transmitting/receiving unit corresponding to the logical path that received this signal with the signal, and outputs the information along with this signal, and in a case of sending out a signal to the logical path, sends out the signal to a logical path corresponding to the physical port transmitting/receiving unit specified as a transfer destination of this signal.

2. The signal transfer system according to claim 1,
wherein, in a case in which a signal that the physical port transmitting/receiving unit receives and outputs through the physical line matches a transfer condition set in advance, the transfer processing unit outputs the signal to another of the physical port transmitting/receiving units, and in a case of the signal not matching the transfer condition, correlates information identifying the physical port transmitting/receiving unit that received this signal with the signal, and outputs the information to the terminal-side logical path transmitting/receiving unit along with this signal,
and wherein, in a case of receiving the signal, and information identifying the physical port transmitting/receiving unit correlated with this signal, from the transfer processing unit, the terminal-side logical path transmitting/receiving unit sends out the signal to the logical path corresponding to the information identifying the physical port transmitting/receiving unit.

3. The signal transfer system according to claim 1,
wherein, in a case of receiving the signal through the logical path, the terminal-side logical path transmitting/receiving unit correlates information, identifying the physical port transmitting/receiving unit corresponding to the logical path that received the signal, with the signal, and outputs the information to the transfer processing unit along with the signal,
and wherein, in a case of receiving the signal and the information identifying the physical port transmitting/receiving unit correlated with the signal from the terminal-side logical path transmitting/receiving unit, the transfer processing unit outputs the signal to the physical port transmitting/receiving unit that the information identifying the physical port transmitting/receiving unit indicates.

4. The signal transfer system according claim 1,
wherein the proxy transfer agent device is provided with a proxy transfer processing unit that takes in the signal output by the proxy-side logical path transmitting/receiving unit, and information identifying the physical port transmitting/receiving unit that is correlated with the signal, and that, in a case in which the signal that is taken in is a signal that matches a transfer condition specified from a network control device connected to the own device, transfers the signal and the information identifying the physical port transmitting/receiving unit to the network control device, and in a case of receiving a signal of which the network control device is the sending source and information identifying the physical port transmitting/receiving unit correlated with this signal, outputs the signal and the information identifying the physical port transmitting/receiving unit that is correlated with this signal to the proxy-side logical path transmitting/receiving unit,
and wherein, in a case of receiving the signal and the information identifying the physical port transmitting/receiving unit correlated with this signal from the proxy transfer processing unit, the proxy-side logical path transmitting/receiving unit sends out the signal to the logical path corresponding to the information identifying the physical port transmitting/receiving unit.

5. The signal transfer system according to claim 1,
wherein the terminal-side logical path transmitting/receiving unit and the proxy-side logical path transmitting/receiving unit generate the logical paths to be correlated with part or all of the physical port transmitting/receiving units in a one-on-one manner.

6. A terminal function device, comprising:
a plurality of physical port transmitting/receiving units to each of which a physical line is connected, and that perform transmission/reception of signals through the physical lines;
a transfer processing unit that connects to each of the physical port transmitting/receiving units and that performs transfer processing of signals output by the physical port transmitting/receiving unit, or signals output to the physical port transmitting/receiving units; and
a terminal-side logical path transmitting/receiving unit that generates a logical path to be correlated with the physical port transmitting/receiving unit on one of the physical lines, and that, in a case of receiving a signal from the transfer processing unit, sends out the signal to a logical path corresponding to the physical port transmitting/receiving unit that received this signal, and in a case of receiving a signal through the logical path, outputs the signal to the transfer processing unit with the physical port transmitting/receiving unit corresponding the logical path that received this signal specified as a transfer destination thereof.

7. (cancel)

8. A signal transfer method in a signal transfer system including a terminal function device that includes a plurality of physical port transmitting/receiving units that perform transmission/reception of signals through physical lines respectively connected thereto, and a proxy transfer agent device that connects to the terminal function device through one of the physical lines, the method comprising:
the terminal function device and the proxy transfer agent device generating, on the mutually-connecting physical lines, logical paths to be correlated with the physical port transmitting/receiving units;
the terminal function device, in a case of receiving a signal received at one of the physical port transmitting/receiving units, sending the signal out to a logical path corresponding to the physical port transmitting/receiving unit that received this signal;
the proxy transfer agent device, in a case of receiving a signal through the logical path, correlating the signal with information identifying the physical port transmitting/receiving unit corresponding to the logical path that received this signal, and transferring the information along with the signal;
the proxy transfer agent device, in a case of sending out a signal to the logical path, sending out the signal to the logical path corresponding to the physical port transmitting/receiving unit specified as a transfer destination of the signal; and
the terminal function device, in a case of receiving a signal through the logical path, sending out the signal from the physical port transmitting/receiving unit corresponding to the logical path that received the signal.
